(19) United States
(12) Patent Application Publication
(10) Pub. No.: US 2018/0336595 A1
(43) Pub. Date: Nov. 22, 2018

(54) METHOD, APPARATUS AND COMPUTER PROGRAM PRODUCT FOR DATA TRANSMISSION BASED ON LOCATION PROXIMITY

(71) Applicant: Move, Inc., Westlake Village, CA (US)

(72) Inventors: Scott Rutherford, Westlake Village, CA (US); Neeraj Garg, Westlake Village, CA (US)

(21) Appl. No.: 15/982,309

(22) Filed: May 17, 2018

Related U.S. Application Data
(60) Provisional application No. 62/507,584, filed on May 17, 2017.

(51) Int. Cl. G06Q 30/02; H04W 4/80; H04L 29/08

(52) U.S. Cl. CPC G06Q 30/0261; G06Q 50/16; H04L 67/10; H04W 4/80

(57) ABSTRACT

Methods, apparatus and computer program product for creating an externally shared data channel in a network database platform are described herein. A computer-implemented method may include receiving, via a network, an electronic indication including a property identification; retrieving, from a network database, a property information dataset based on the property identification; generating, by a processor, an electronic user interface trigger based on the property information dataset; and transmitting, to a client device, the electronic user interface trigger.

### CROSS-REFERENCE TO RELATED APPLICATIONS

This application claims priority to and the benefit of U.S. Provisional Patent Application Ser. No. 62/507,584, entitled “Method, Apparatus and Computer Program Product For Data Transmission Based On Location Proximity” and filed on May 17, 2017, the entire contents of which are hereby incorporated by reference.

### BACKGROUND

Various systems are configured to facilitate data transmission based on location. Applicant has identified many deficiencies and problems associated with existing systems. Through applied effort, ingenuity, and innovation, many of these identified deficiencies and problems have been solved by developing solutions that are in accordance with the embodiments of the present invention, many examples of which are described in detail herein.

### BRIEF SUMMARY

Embodiments of the invention relate, generally, to facilitating data transmission based on location. In some embodiments, a computer-implemented method includes receiving, via a network, an electronic indication including a property identification; retrieving, from a network database, a property information dataset based on the property identification; and generating, by a processor, an electronic user interface trigger based on the property information dataset.

In some embodiments, the property indication is a Uniform Resource Locator (URL), and the electronic user interface trigger is an electronic notification. In some embodiments, the computer-implemented method further includes receiving a user input in response to the electronic notification, wherein the user input indicates an acceptance, and generating an electronic user interface.

In some embodiments, the electronic indication is generated based on a location proximity indication received from a Bluetooth beacon, and the location proximity indication indicates a location proximity between the client device and the Bluetooth beacon.

In some embodiments, a computer-implemented method further includes determining, by the processor, whether the location proximity satisfies a proximity threshold; and in response to the location proximity satisfying the proximity threshold, identifying, based on the property identification, the network database.

In some embodiments, the proximity threshold is determined based on at least one of a user input and a global parameter.

In some embodiments, a computer-implemented method further includes receiving, via the network, a property information update query, wherein the property information update query includes an updated property information dataset; generating, based on the updated property information dataset, an updated electronic user interface trigger; and transmitting the updated electronic user interface trigger.

In some embodiments, an apparatus comprising at least one processor and at least one non-transitory memory including computer program code is provided. The at least one memory and the computer program code may be configured to, with the processor, cause the apparatus to receive, via a network, an electronic indication including a property identification; retrieve, from a network database, a property information dataset based on the property identification; and generate, by a processor, an electronic user interface trigger based on the property information dataset.

In some embodiments, a computer program product for facilitating data transmission is provided. The computer program product may comprise at least one computer-readable storage medium having computer-readable program code portions stored therein, the computer-readable program code portions comprising executable portions configured to receive, via a network, an electronic indication including a property identification; retrieve, from a network database, a property information dataset based on the property identification; and generate, by a processor, an electronic user interface trigger based on the property information dataset.

### BRIEF DESCRIPTION OF THE DRAWINGS

Having thus described some embodiments in general terms, references will now be made to the accompanying drawings, which are not necessarily drawn to scale, and wherein:

FIG. 1 is an exemplary system architecture diagram of a property database platform in accordance with some embodiments of the present invention;

FIG. 2 is an exemplary schematic diagram of a property database server in accordance with some embodiments of the present invention;

FIG. 3 is an exemplary flow chart illustrating an exemplary method in accordance with some embodiments of the present invention;

FIG. 4 is an exemplary flow chart illustrating an exemplary method in accordance with some embodiments of the present invention; and

FIG. 5 is an exemplary flow chart illustrating an exemplary method in accordance with some embodiments of the present invention.

### DETAILED DESCRIPTION OF VARIOUS EMBODIMENTS

Various embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### Overview

Various embodiments of the invention relate generally to the facilitation of data transmission based on location. More specifically, the invention may utilize the Bluetooth Low-Energy beacon technology to selectively transmit data based on location proximity. Such data may include information related to a for-sale property and/or a real estate agent.

For example, a property database platform configured in accordance with various embodiments of the invention may prompt a user, who is visiting an open house, on or near a for-sale property, or close to a real estate agent, with information related to the property on a client device, such as a mobile phone having a mobile application developed by Realtor.com. In some cases, the property database platform may utilize Instant Apps and Nearby Service technology, allowing information to be prompted on a mobile phone that does not have relevant mobile application installed.

From consumer experience perspective, systems structured in accordance with various embodiments of the invention provide seamless experience for consumers to be notified of a nearby property for sale or an open house event. Such systems also allow consumers to easily obtain details related to the for-sale property via a single click or touch on their devices. Other examples include real estate agents or broker websites, and lists of properties for sale by a particular agent or brokerage.

From real estate agents' perspective, systems structured in accordance with various embodiments of the invention greatly reduce the cost to notify consumers or potential consumers of property details, while simplifying the notification process. They further enhance efficiency of real estate agent in distributing information related to for-sale properties, and provide those agents with a broader consumer reach. Further, systems structured in accordance with various embodiments of the invention may allow real estate agents to configure or re-configure information related to the property with low friction, i.e. a “one-touch solution.”

Further, systems constructed according to various embodiments of the invention may allow a URL to be pre-loaded on the Bluetooth beacon. For example, the URL may be displayed as a notification in a client device, allowing a user to launch that URL by a simple tap. The user interface may be generated by a server, or in the client device. In contrast, other systems or platforms that do not incorporate the inventive embodiments discussed herein (“deficient systems”) may be plagued by limitations and inefficiencies. For example, some deficient systems may use the Global Position System (GPS) technology to identify the proximity of a mobile device as to the location of a property. Such deficient systems require the mobile device to constantly report its geographic locations to a remote server, which drains the battery life of the mobile device. Such deficient systems also burden the property owner or the real estate agent to obtain the precise geographic coordinates of the property location.

As such, systems structured in accordance with various embodiments of the invention provide specific, technical solutions to technical problems faced by existing systems, the details of which are described hereinafter.

### Definitions

As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like. Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearable devices, personal computers, enterprise computers, and the like.

The term “property database platform” refers to a collection of computing services that are accessible to one or more client devices, and that are operable to provide access to a plurality of software applications related to operations of databases. Such databases may store information related to for-sale properties, real estate agents, and the like. In some examples, the property database platform may take the form of one or more central servers disposed in communication with one or more databases storing digital content items, application-related data, and/or the like.

The term “property database” refers to a collection of data in a computer network that is organized so that its contents can easily be accessed, managed, and updated. Property databases contain aggregations of datasets related to for-sale properties, such as offer price, offer window, and real estate agent information. Property databases may be a relational database, distributed database, cloud database, Not Only SQL (NoSQL) database, object-oriented database, graph database, and the like.

The term “dataset” refers to a collection of related, discrete items of data that may be accessed individually, or in combination or managed as a whole entity. Usually, a dataset is organized into some type of data structure. In a property database, for example, a dataset might contain a collection of data related to real properties (e.g. location, price, and real estate agent information of a for-sale property).

The term “query” refers to a request associated with a database. A “query” may be generated on one or more client devices, and may be transmitted to a property database platform. A query may be a “select query,” which is used to extract data from the database in a readable format according to the query. A query may be an “action query,” which asks for operations (such as insertion, deletion, and/or updating) on the data stored in a property database. For example, a “property information update query” is an action query that requests updating a dataset related to a real property.

The term “electronic user interface” refers to an interface (e.g., a graphic user interface of GUI) associated with a property database platform, which allows a user to communicate with a client device and the property database platform. An electronic user interface may be generated based on an electronic user interface trigger, which could be, for example, a Uniform Resource Locator (URL). The electronic user interface may be embodied by graphic or visual elements (e.g., dialog boxes, menus, icons, scroll bars) that are displayed via touchscreen display of a client device, and which allow a user to send a request (e.g., one or more user inputs) to a property database platform via one or more input devices (e.g., the touchscreen display, a mouse, a keyboard) of the client device.

The term “Bluetooth beacon” refers to hardware signal transmitter built based on the Bluetooth Low-Energy (LE) technology. Bluetooth beacons broadcast electronic signals to nearby portable electronics devices, including smartphones, tablet computers, wearable devices, and the like. Such electronic signals may be picked up by a compatible app or the operating system of the portable electronic devices. For example, a mobile phone may pick up an electronic signal from a Bluetooth beacon that indicates the proximity between the mobile phone and the Bluetooth beacon.

### Example System Architecture

Methods, apparatuses, and computer program products of the present invention may be embodied by any of a variety of devices. For example, the method, apparatus, and computer program product of an example embodiment may be embodied by a network device, such as a server or other network entity, configured to communicate with one or more devices, such as one or more client devices. In some preferred and non-limiting embodiments, the computing device may include fixed computing devices, such as a personal computer or a computer workstation. Still further, example embodiments may be embodied by any of a variety of mobile devices, such as a portable digital assistant (PDA), mobile phone, smartphone, laptop computer, tablet computer, wearable device, or any combination of the aforementioned devices.

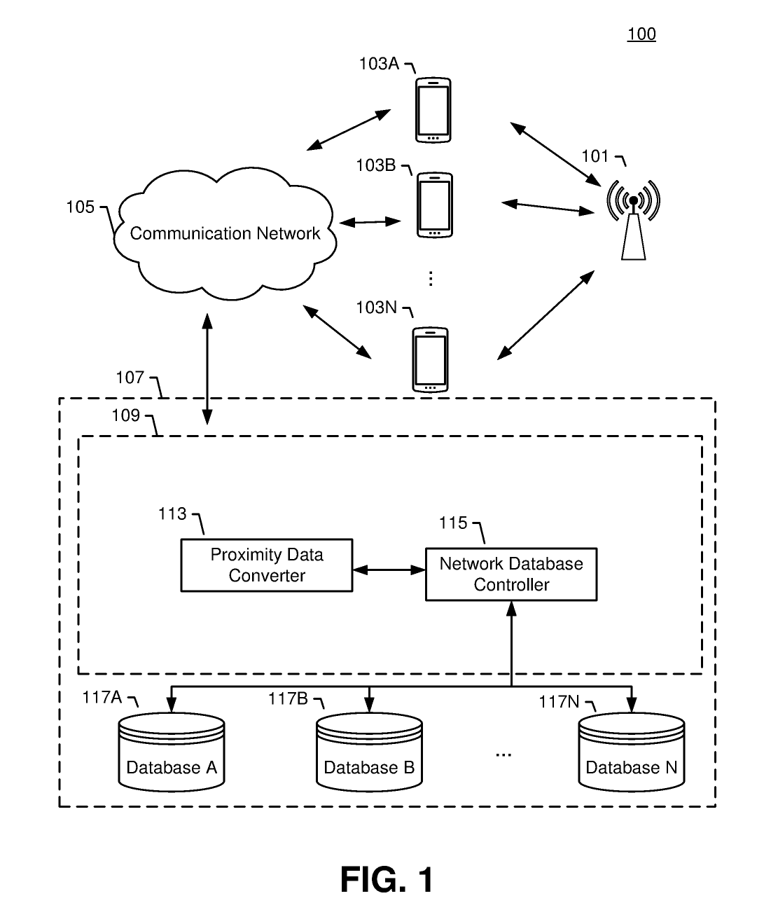

FIG. 1 illustrates an example computing system within which embodiments of the present invention may operate. Users may access a property database platform 107 via a communication network 105 (e.g., the Internet, Wi-Fi, LAN, WAN, or the like) using client devices 103A-103N based on location proximity indications received from the Bluetooth beacon 101. The property database platform 107 may comprise a server 109 in communication with one or more databases 117A-117N. The server 109 may comprise a proximity data converter 113 and a network application controller 115 in communication with one or more databases 117A-117N.

The Bluetooth beacon 101 may be built based on Bluetooth BLE standards, such as iBeacon standard, Eddystone standard, AltBeacon standard, and the like. In addition, various embodiments of the invention may implement more than one Bluetooth beacon.

The server 109 may be embodied as a computer or computers as known in the art. The server 109 may provide for receiving of electronic data from various sources, including but not limited to the client devices 103A-103N. For example, the server 109 may be operable to receive and process electronic indications provided by the client devices 103A-103N. The server 109 may also facilitate the generation and providing of various electronic user interface triggers and electronic user interfaces.

The client devices 103A-103N may be any computing device as defined above. Electronic data received by the server 109 from the client devices 103A-103N may be provided in various forms and via various methods.

In some preferred and non-limiting embodiments, one or more of the client devices 103A-103N are mobile devices, such as smartphones or tablet computers. The one or more client devices may execute an “app” to interact with the server 109. Such apps are typically designed to execute on mobile devices, such as tablets or smartphones. For example, an app may be provided that executes on mobile device operating systems such as Apple Inc.'s iOS®, Google Inc.'s Android®, or Microsoft Inc.'s Windows 10 Mobile®. These platforms typically provide frameworks that allow apps to communicate with one another and with particular hardware and software components of mobile devices. Communication with hardware and software modules executing outside of the app is typically provided via application programming interfaces (APIs) provided by the mobile device operating system.

In some embodiments, the client devices 103A-103N may interact with the server 109 via a web browser. The client devices 103A-103N may utilize the Instant App or other similar technology to access the server 109 without requiring installation of a mobile application. Instant Apps and similar technologies provide for the same look and functionality of a mobile application. The client device 103A-103N may also include various hardware or firmware designed to interact with the server 109.

The databases 117A-117N may be embodied as a data storage device such as a network attached storage (NAS) device or devices, or as a separate database server or servers. For example, the databases 117A-117N may include, without limitation, for-sale property information and/or the like.

An example of a data flow for exchanging electronic information among the Bluetooth beacon 101, one or more client devices 103A-103N and the property database platform 107 is described below.

In the depicted embodiment, the server 109 may receive an electronic indication from one of the client devices 103A-103N. The electronic indication may include an electronic identification, such as a property identification associated with a for-sale property. The property identification may comprise a unique string of alphanumeric characters that identify a physical address of a dataset associated with the for-sale property in one of the databases 117A-117N.

In some embodiments, the electronic indication may be generated based on a location proximity indication received from the Bluetooth beacon 101. The electronic indication may include information related to the proximity between a client device and the Bluetooth beacon 101. For example, when the client device 103A is near the Bluetooth beacon 101, the client device 103A may pick up a location proximity indication from the Bluetooth beacon 101, and generate an electronic indication based on the location proximity indication.

Upon receiving the electronic indication, the server 109 may be configured to retrieve an information dataset based on the electronic indication. For example, the server 109 may retrieve a property information dataset from one of the databases 117A-117N. Such property information may include data, for example, related to the price and the owner of the for-sale property.

In some embodiments, the server 109 may further be configured to determine whether the proximity between the client device and the Bluetooth beacon 101 satisfies a proximity threshold. For example, the proximity threshold may be 5 meters. In this example, only when the server 109 determines that the client device is within 5 meters of the Bluetooth beacon 101, will the server 109 continue with the retrieving the information dataset. If the client device is not within 5 meters of the Bluetooth beacon 101, then no information dataset will be retrieved.

In some embodiments, the proximity threshold may be determined based on a user input or a global parameter. For example, a user may set the proximity threshold to be 10 meters. In another example, the property database platform 107 may apply a global parameter of 10 meters as proximity threshold to all properties. In some embodiments, the proximity threshold will be determined by the broadcast range limit of the specific Bluetooth device chosen.

Further, the server 109 may be configured to generate an electronic user interface trigger based on the retrieved information dataset. For example, the server 109 may generate a Uniform Resource Locator (URL) that identifies the online location of the property information dataset. Upon generating the electronic user interface trigger, the server 109 may transmit the electronic user interface trigger to the client device. In some embodiments, the server 109 may further generate an electronic user interface based on the electronic user interface trigger, and transmit the electronic user interface to the client device.

In some embodiments, the interface trigger can also be directly generated based on the device, either at OS-level (in the case of Android) or at the application level (in the case of iOS). In these embodiments, the URL is pre-loaded on the beacon, and the server is not involved in generating the URL.

### Example Apparatus for Implementing Embodiments of the Present Invention

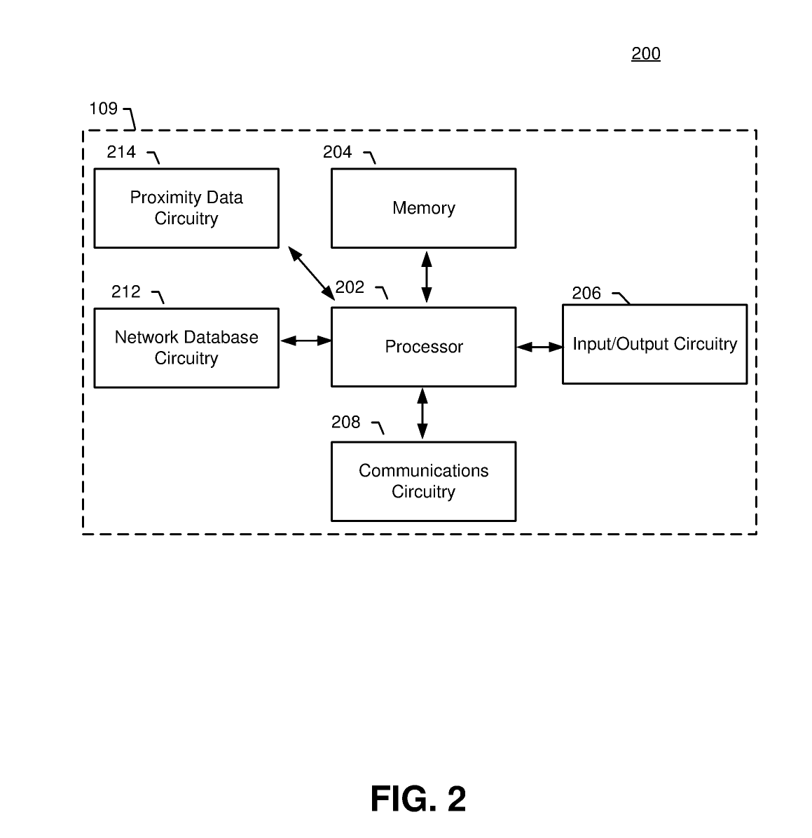

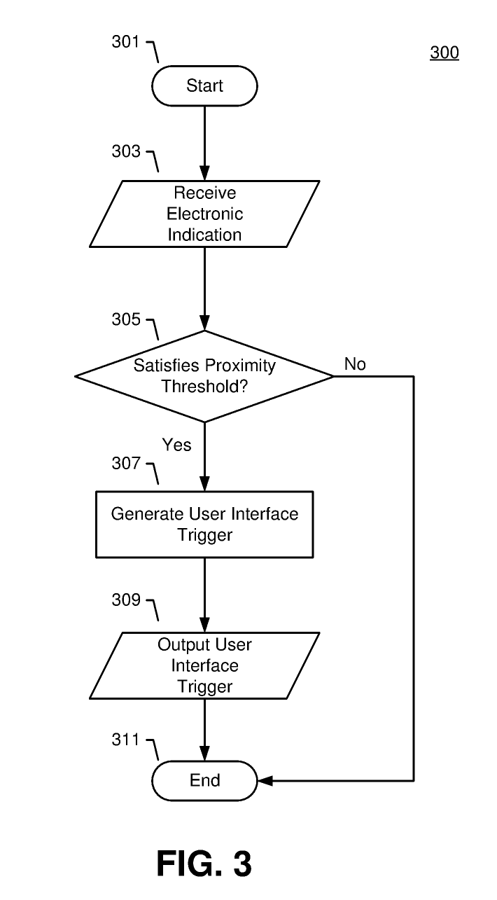

The server 109 may be embodied by one or more computing systems, such as apparatus 200 shown in FIG. 2. The apparatus 200 may include processor 202, memory 204, input/output circuitry 206, communications circuitry 208, network database circuitry 212, and proximity data circuitry 214. The apparatus 200 may be configured to execute the operations described above with respect to FIG. 1 and below with respect to FIGS. 3-5. Although these components 202-214 are described with respect to functional limitations, it should be understood that the particular implementations necessarily include the use of particular hardware. It should also be understood that certain of these components 202-214 may include similar or common hardware. For example, two sets of circuitries may both leverage use of the same processor, network interface, storage medium, or the like to perform their associated functions, such that duplicate hardware is not required for each set of circuitry.

The term “circuitry” should be understood broadly to include hardware and, in some embodiments, software for configuring the hardware. With respect to components of the apparatus, the term “circuitry” as used herein should therefore be understood to include particular hardware configured to perform the functions associated with the particular circuitry as described herein. For example, in some embodiments, “circuitry” may include processing circuitry, storage media, network interfaces, input/output devices, and the like. In some embodiments, other elements of the apparatus 200 may provide or supplement the functionality of particular circuitry. For example, the processor 202 may provide processing functionality, the memory 204 may provide storage functionality, and the like.

In some embodiments, the processor 202 (and/or co-processor or any other processing circuitry assisting or otherwise associated with the processor) may be in communication with the memory 204 via a bus for passing information among components of the apparatus 200. The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be embodied in a number of different ways and may, for example, include one or more processing devices configured to perform independently. Additionally or alternatively, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display and may comprise a web user interface, a mobile application, a client device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication circuitry 208 may include the circuitry for interacting with the antenna(s) to cause transmission of signals via the antenna(s) or to handle receipt of signals received via the antenna(s).

The network database circuitry 212 includes hardware configured to manage one or more network databases, such as databases 117A-117N as illustrated in FIG. 1. The network database circuitry 212 may utilize processing circuitry, such as the processor 202, to perform these actions. However, it should also be appreciated that, in some embodiments, the network database circuitry 212 may include a separate processor, specially configured field programmable gate array (FPGA), or application specific interface circuit (ASIC) for performing the functions described herein. The network database circuitry 212 may be implemented using hardware components of the apparatus configured by either hardware or software for implementing these planned functions.

The proximity data circuitry 214 includes hardware configured to decode proximity data received from one or more client devices, such as client devices 103A-103N illustrated in FIG. 1. The proximity data circuitry 214 may utilize processing circuitry, such as the processor 202, to perform these actions. However, it should also be appreciated that, in some embodiments, the proximity data circuitry 214 may include a separate processor, specially configured field programmable gate array (FPGA), or application specific interface circuit (ASIC) for performing the functions described herein. The proximity data circuitry 214 may be implemented using hardware components of the apparatus configured by either hardware or software for implementing these planned functions.

As will be appreciated, any such computer program instructions and/or other type of code may be loaded onto a computer, processor or other programmable apparatus's circuitry to produce a machine, such that the computer, processor or other programmable circuitry that execute the code on the machine create the means for implementing various functions, including those described herein.

It is also noted that all or some of the information presented by the example displays discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Processes for Facilitating Data Transmission Based on Location

FIGS. 3, 4, and 5 illustrate various processes according to various embodiments of the invention.

Referring now to FIG. 3, an example process 300 is shown. The process 300 may be performed by an apparatus, such as the apparatus 200 described above with respect to FIG. 2.

The process 300 starts at block 301. At block 303, an apparatus, such as apparatus 200, may be configured to receive an electronic indication. The electronic indication may include a property identification. Further, the electronic indication may be generated based on a location proximity indication received from a Bluetooth beacon. The location proximity indication may further include a location proximity between a client device and the Bluetooth beacon.

At block 305, an apparatus, such as apparatus 200, may be configured to determine whether the location proximity satisfies a proximity threshold. In response to determining that the location proximity satisfies the proximity threshold, an apparatus, such as apparatus 200, may be configured to generate a user interface trigger at block 307. At block 309, an apparatus, such as apparatus 200, may be configured to output the user interface trigger to one or more client devices. During the process of generating and outputting the user interface trigger, an apparatus, such as apparatus 200, may be configured to acquire new users for services provided by Realtor.com. Thus, the present invention enables an efficient way to attract new users to Realtor.com.

In some embodiments, the user interface trigger may further comprise a map of the area of the Bluetooth beacon, wherein the map provides other properties that are within the current location of the one or more client devices.

In response to determining that the location proximity does not satisfy the proximity threshold, the process 300 ends at block 311.

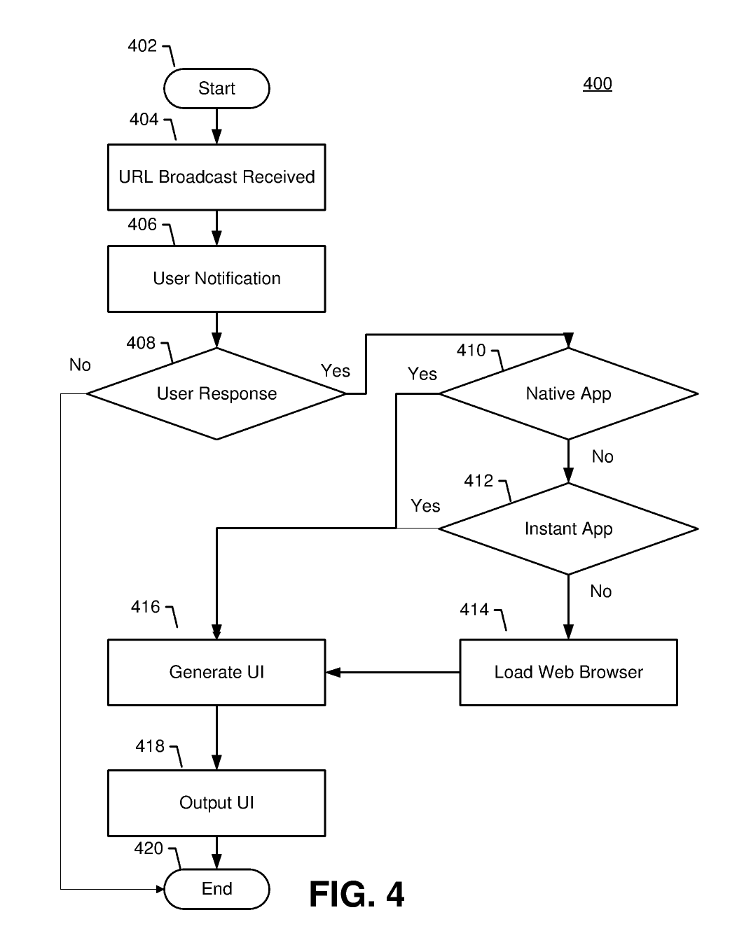

Referring now to FIG. 4, an example process 400 is shown. The process 400 illustrates an example process for generating an electronic user interface in accordance with embodiments of the invention.

The process 400 starts at block 402. At block 404, a client device may receive a URL broadcasted by a Bluetooth beacon. At block 406, the client device may generate a user notification based on the URL. At block 408, the client device may receive a user response as to the notification. If the user response is yes, then the client device determines whether a native app is available on the client device at block 410.

If the client device determines that a native app is available on the client device at block 410, then the client device generates a user interface at block 416. If the client device determines that a native app is not available on the client device at block 410, then the client device determines whether an instant app is available at block 412. The client device is configured to check whether an instant app is enabled. If an instant app is available, then the client device generates a user interface at block 416. In certain embodiments, the user interface that is generated by an instant app may have the same visual elements and functionality as the mobile application. Alternatively or additionally, the user interface that is generated by an instant app may be specifically targeted so as to deliver a portion of the mobile application to a user with an option to download the full mobile application displayed via the user interface. If the client device does not support the instant app, then the client device loads a web browser at block 414. In certain embodiments, the client device is configured to generate and output a prompt for enabling an instant app via the client device settings.

Further, the process 400 outputs the user interface at block 418, and ends in block 420.

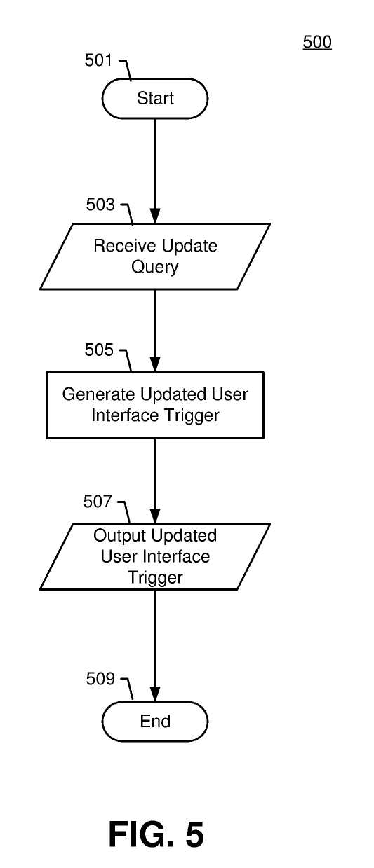

Referring now to FIG. 5, an example process 500 is shown. The process 500 illustrates an example process for updating a property dataset in accordance with embodiments of the invention. The process 500 may be performed by an apparatus, such as the apparatus 200 described above with respect to FIG. 2.

The process 500 start at block 501. At block 503, an apparatus, such as apparatus 200, may be configured to receive a property information update query. The property information update query may include an updated property information dataset. For example, the property information update query may include updated information related to the pricing of a for-sale property, and the apparatus 200 may update the dataset related to the pricing for the for-sale property.

An apparatus, such as apparatus 200, may be further configured to generate an updated user interface trigger based on the updated property information dataset at block 505. At block 507, an apparatus, such as apparatus 200, may be configured to transmit the updated user interface trigger. The process 500 ends at block 509. The apparatus, such as apparatus 200, may be further configured to reduce the amount of data that needs to be sent with the updated user interface trigger, for example, the updated user interface trigger may only contain changed data such as the pricing change.

In some embodiments, a URL may be loaded to a Bluetooth beacon, and, when an update query is received, the Bluetooth beacon owner can update the Bluetooth beacon with a new URL. In these embodiments, the property data resides on the server, which may be updated through a database query. It is this data which is retrieved when the user interface trigger is triggered (for example, when a user taps notification with its embedded URL) and populated into a user interface (for example, mobile webpage, app, or instant app).

In further embodiments, property statistics may be provided (e.g., popularity of property based on number of user interface triggers generated) to create benchmarks and provide area statistics.

### Additional Implementation Details

Although an example processing system has been described in FIG. 2, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Conclusion

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed:

1. A computer-implemented method for facilitating data transmission based on location, the computer-implemented method comprising:
receiving, via a network, an electronic indication including a property identification;
retrieving, from a network database, a property information dataset based on the property identification; and
generating, by a processor, an electronic user interface trigger based on the property information dataset

2. A computer-implemented method according to claim 1, wherein the property indication is a Uniform Resource Locator (URL), and the electronic user interface trigger is an electronic notification.

3. A computer-implemented method according to claim 2, further comprising:
receiving a user input in response to the electronic notification, wherein the user input indicates an acceptance; and
generating an electronic user interface.

4. A computer-implemented method according to claim 1, wherein the electronic indication is generated based on a location proximity indication received from a Bluetooth beacon, wherein the location proximity indication indicates a location proximity between a client device and the Bluetooth beacon.

5. A computer-implemented method according to claim 4, further comprising:
determining, by the processor, whether the location proximity satisfies a proximity threshold; and
in response to the location proximity satisfying the proximity threshold, identifying, based on the property identification, the network database.

6. A computer-implemented method according to claim 5, wherein the proximity threshold is determined based on at least one of a user input and a global parameter.

7. A computer-implemented method according to claim 1, further comprising:
receiving, via the network, a property information update query, wherein the property information update query includes an updated property information dataset;
generating, based on the updated property information dataset, an updated electronic user interface trigger; and
transmitting the updated electronic user interface trigger.

8. An apparatus for facilitating data transmission based on location, the apparatus comprising at least one processor and at least one non-transitory memory including program code, the at least one non-transitory memory and the program code configured to, with the processor, cause the apparatus to at least:
receive, via a network, an electronic indication including a property identification;
retrieve, from a network database, a property information dataset based on the property identification; and
generate, by a processor, an electronic user interface trigger based on the property information dataset.

9. An apparatus according to claim 8, wherein the property indication is a Uniform Resource Locator (URL), and the electronic user interface trigger is an electronic notification.

10. An apparatus according to claim 9, wherein the at least one non-transitory memory and program code are further configured to, with the processor, cause the apparatus to:
receiving a user input in response to the electronic notification, wherein the user input indicates an acceptance; and
generating an electronic user interface.

11. An apparatus according to claim 8, wherein the electronic indication is generated based on a location proximity indication received from a Bluetooth beacon, wherein the location proximity indication indicates a location proximity between the client device and the Bluetooth beacon.

12. An apparatus according to claim 11, wherein the at least one non-transitory memory and program code are further configured to, with the processor, cause the apparatus to:
determine, by the processor, whether the location proximity satisfies a proximity threshold; and
in response to the location proximity satisfying the proximity threshold, identify, based on the property identification, the network database.

13. An apparatus according to claim 12, wherein the proximity threshold is determined based on at least one of a user input and a global parameter.

14. An apparatus according to claim 10, wherein the at least one non-transitory memory and program code are further configured to, with the processor, cause the apparatus to:
receive, via the network, a property information update query, wherein the property information update query includes an updated property information dataset;
generate, based on the updated property information dataset, an updated electronic user interface trigger; and
transmit, to the client device, the updated electronic user interface trigger.

15. A computer program product for facilitating data transmission based on location, the computer program product comprising at least one non-transitory computer-readable storage medium having computer-readable program code portions stored therein, the computer-readable program code portions comprising an executable portion configured to:
receive, via a network, an electronic indication including a property identification;
retrieve, from a network database, a property information dataset based on the property identification; and
generate, by a processor, an electronic user interface trigger based on the property information dataset.

16. A computer program product according to claim 15, wherein the property indication is a Uniform Resource Locator (URL), and the electronic user interface trigger is an electronic notification.

17. A computer program product according to claim 16, wherein the executable portion of the computer-readable program code portions is further configured to:
receive a user input in response to the electronic notification, wherein the user input indicates an acceptance; and
generate an electronic user interface.

18. A computer program product according to claim 15, wherein the electronic indication is generated based on a location proximity indication received from a Bluetooth beacon, wherein the location proximity indication indicates a location proximity between the client device and the Bluetooth beacon.

19. A computer program product according to claim 18, wherein the executable portion of the computer-readable program code portions is further configured to:
determine, by the processor, whether the location proximity satisfies a proximity threshold; and
in response to the location proximity satisfying the proximity threshold, identify, based on the property identification, the network database.

20. A computer program product according to claim 19, wherein the proximity threshold is determined based on at least one of a user input and a global parameter.

21. A computer program product according to claim 15, wherein the executable portion of the computer-readable program code portions is further configured to:
receive, via the network, a property information update query, wherein the property information update query includes an updated property information dataset;
generate, based on the updated property information dataset, an updated electronic user interface trigger; and
transmit, to the client device, the updated electronic user interface trigger.

22. A system comprising:
a Bluetooth beacon, wherein the Bluetooth beacon is configured to
transmit an electronic indication indicating a URL;
a client device comprising at least one processor and at least one non-transitory memory including computer program code, the at least one non-transitory memory and the computer program code configured to, with the processor, cause the client device to at least:
receive the electronic indication;
display a notification based on the URL;
receive a user response to generate a user interface based on the notification; and
generate the user interface.
